(19) United States
(12) Patent Application Publication
(10) Pub. No.: US 2017/0223382 A1
(43) Pub. Date: Aug. 3, 2017

(54) METHOD OF REDUCING LATENCY AND A VIDEO DECODER OF THE SAME

(71) Applicant: Sigma Designs, Inc., Fremont, CA (US)

(72) Inventor: Vincent Trinh, Pleasanton, CA (US)

(73) Assignee: Sigma Designs, Inc., Fremont, CA (US)

(21) Appl. No.: 15/015,087

(22) Filed: Feb. 3, 2016

(51) Int. Cl. H04N 19/85; H04N 5/04; H04N 19/44

(52) U.S. Cl. CPC H04N 19/85; H04N 19/44; H04N 5/04

(57) ABSTRACT

A method of reducing latency, comprising generating a vertical synchronization signal (VSYNC); detecting whether at least a part of a picture has been received; synchronizing the generation of the vertical synchronization signal to a video decoding upon detecting receiving of the at least a part of the picture.

### TECHNICAL FIELD

The present invention relates to video decoding, and more particularly, but not limited to a method of reducing latency and a video decoder of the same.

### BACKGROUND

Conventionally, a VSYNC signal is started asynchronously from a decoder, therefore there may be a latency of up to one VSYNC period, depending on when the initial frame is received and decoded.

### SUMMARY

In one aspect of the invention, a method of reducing latency comprises generating a vertical synchronization signal (VSYNC); detecting whether at least a part of a picture has been received; synchronizing the generation of the vertical synchronization signal to a video decoding of the at least a part of the picture upon detecting an receiving of the at least the part of the picture; and displaying the decoded at least a part of a picture.

In another aspect of the invention, a circuit for reducing latency comprises: a signal generator, configured to generate a vertical synchronization signal (VSYNC); a detector configured to detect whether at least a part of a picture has been received; a synchronizer configured to synchronize the generation of the vertical synchronization signal to a video decoding of the at least a part of the picture upon detecting receiving of the at least the part of the picture; and a displaying unit, configured to display the decoded at least a part of a picture.

### BRIEF DESCRIPTION OF THE DRAWINGS

The present invention is illustrated in an exemplary manner by the accompanying drawings. The drawings should be understood as exemplary rather than limiting, as the scope of the invention is defined by the claims. In the drawings, the identical reference signs represent the same elements.

FIG. 1 is a diagram illustrating a network environment according to an embodiment of the invention.

FIG. 2 is a schematic illustration of one embodiment of a computer system 200 that can perform the methods and techniques provided by various other embodiments of the invention.

FIG. 3 is a flowchart illustrating a method 300 of reducing latency according to an embodiment of the invention.

FIG. 4 is a diagram illustrating a time sequence for VSYNC signal according to an embodiment of the invention.

FIG. 5 is a block diagram illustrating a circuit according to an embodiment of the invention.

### DETAILED DESCRIPTION

References in this description to “an embodiment”, “one embodiment”, or the like, mean that the particular feature, function, structure or characteristic being described is included in at least one embodiment of the present invention. Occurrences of such phrases in this specification do not necessarily all refer to the same embodiment. On the other hand, such references are not necessarily mutually exclusive either.

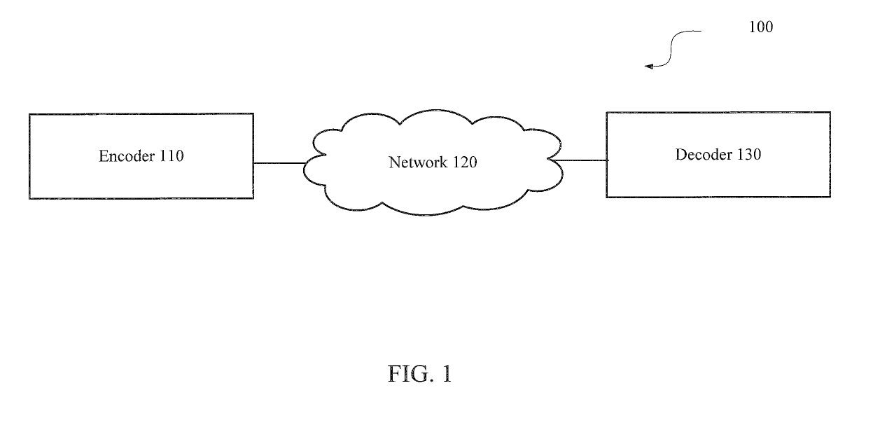

FIG. 1 is a diagram illustrating a network environment 100 according to an embodiment of the invention. The network environment 100 comprises an encoder 110, a network 120 and a decoder 130. The encoder 110 communicates with the decoder 130 via the network 120. The network 120 may be a wired or wireless network.

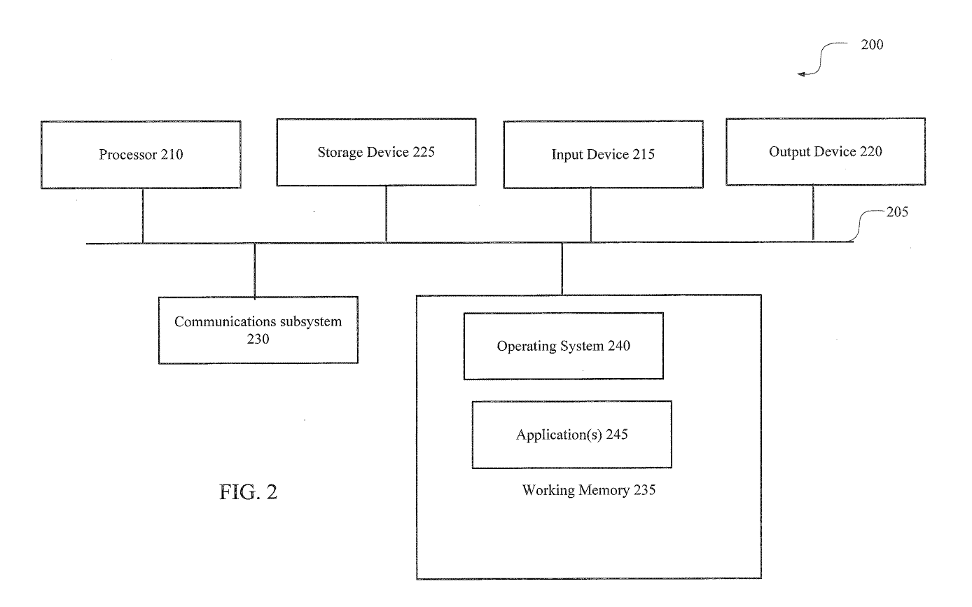

FIG. 2 is a schematic illustration of one embodiment of a computer system 200 that can perform the methods and techniques provided by various other embodiments, as described herein, and/or can function as a video communication device. It should be noted that FIG. 2 is meant only to provide a generalized illustration of various components, of which one or more (or none) of each may be utilized as appropriate. FIG. 2, therefore, broadly illustrates how individual system elements may be implemented in a relatively separated or relatively more integrated manner.

The computer system 200 is shown comprising hardware elements that can be electrically coupled via a bus 205 (or may otherwise be in communication, as appropriate). The hardware elements may include one or more processors 210, including without limitation one or more general-purpose processors and/or one or more special-purpose processors (such as digital signal processing chips, graphics acceleration processors, and/or the like); one or more input devices 215 (or interfaces therefore), which can include without limitation a video source such as a camera, a touch screen, a mouse, a keyboard and/or the like; and one or more output devices 220 (or interfaces therefore), which can include without limitation a video sink such as a display device, a printer and/or the like.

The computer system 200 may further include (and/or be in communication 2ith) one or more storage devices 225, which can comprise, without limitation, local and/or network accessible storage, and/or can include, Without limitation, a disk drive, a drive array, an optical storage device, solid-state storage device such as a random access memory (“RAM”) and/or a read-only memory (“ROM”), which can be programmable, flash-updatable and/or the like. Such storage devices may be configured to implement any appropriate data stores, including without limitation, various file systems, database structures, and/or the like.

The computer system 200 might also include a communications subsystem 230, which can include without limitation a modem, a network card (wireless or wired), an infrared communication device, a wireless communication device and/or chipset (such as a Bluetooth™ device, an 802.11 device, a Wi-Fi device, a WiMAX device, a WLAN device, cellular communication facilities, etc.), and/or the like. The communications subsystem 230 may permit data to be exchanged with a network (such as the network described below, to name one example), with other computer systems, and/or with any other devices described herein. In many embodiments, the computer system 200 will further comprise a working memory 235, which can include a RAM or ROM device, as described above.

The computer system 200 also may comprise software elements, shown as being currently located within the working memory 235, including an operating system 240, device drivers, executable libraries, and/or other code, such as one or more application programs 245, which may comprise computer programs provided by various embodiments, and/or may be designed to implement methods, and/or configure systems, provided by other embodiments, as described herein. Merely by way of example, one or more procedures described with respect to the techniques and method discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be encoded and/or stored on a non-transitory computer readable storage medium, such as the storage device(s) 225 described above. In some cases, the storage medium might be incorporated within a computer system, such as the system 200. In other embodiments, the storage medium might be separate from a computer system (i.e., a removable medium, such as a compact disc, etc.), and/or provided in an installation package, such that the storage medium can be used to program, configure and/or adapt a general purpose computer with the instructions/code stored thereon. These instructions might take the form of executable code, which is executable by the computer system 800 and/or might take the form of source and/or installable code, which, upon compilation and/or installation on the computer system 800 (e. g., using any of a variety of generally available compilers, installation programs, compression/decompression utilities, etc.) then takes the form of executable code.

It will be apparent to those skilled in the art that substantial variations may be made in accordance with specific requirements. For example, customized hardware (such as programmable logic controllers, field-programmable gate arrays, application-specific integrated circuits, and/or the like) might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer system (such as the computer system 800) to perform methods in accordance with various embodiments of the invention. According to a set of embodiments, some or all of the procedures of such methods are performed by the computer system 200 in response to one or more processors 210 executing one or more sequences of one or more instructions (which might be incorporated into the operating system 240 and/or other code, such as an application program 245, processing block, etc.) contained in the working memory 235. Such instructions may be read into the working memory 235 from another computer readable medium, such as one or more of the storage device(s) 225.

Merely by way of example, execution of the sequences of instructions contained in the working memory 235 might cause the processor(s) 210 to perform one or more procedures of the methods described herein.

The terms “machine readable medium” and “computer readable medium,” as used herein, refer to any medium that participates in providing data that causes a machine to operation in a specific fashion. In an embodiment implemented using the computer system 200, various computer readable media might be involved in providing instructions/code to processor(s) 210 for execution and/or might be used to store and/or carry such instructions/code (e.g., as signals).

In many implementations, a computer readable medium is a non-transitory, physical and/or tangible storage medium. Such a medium may take many forms, including but not limited to non-volatile media, volatile media, and transmission media. Non-volatile media includes, for example, optical and/or magnetic disks, such as the storage device(s) 225.

Volatile media includes, without limitation, dynamic memory, such as the working memory 235. Transmission media includes, without limitation, coaxial cables, copper wire and fiber optics, including the wires that comprise the bus 205, as well as the various components of the communication subsystem 230 (and/or the media by which the communications subsystem 230 provides communication with form of waves (including without limitation radio, acoustic and/or light Waves, such as those generated during radio wave and infra-red data communications).

Common forms of physical and/or tangible computer readable media include, for example, a floppy disk, a flexible disk, a hard disk, magnetic tape, or any other magnetic medium, a CD-ROM, any other optical medium, punch cards, paper tape, any other physical medium With patterns of holes, a RAM, a PROM, an EPROM, a FLASH-EPROM, any other memory chip or cartridge, a carrier wave as described hereinafter, or any other medium from which a computer can read instructions and/or code.

Various forms of computer readable media may be involved in carrying one or more sequences of one or more instructions to the processor(s) 210 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 200. These signals, which might be in the form of electromagnetic signals, acoustic signals, optical signals and/or the like, are all examples of carrier waves on which instructions can be encoded, in accordance with various embodiments.

The communications subsystem 230 (and/or components thereof) generally Will receive the signals, and the bus 205 then might carry the signals (and/or the data, instructions, etc. carried by the signals) to the working memory 235, from which the processor(s) 205 retrieves and executes the instructions. The instructions received by the working memory 235 may optionally be stored on a storage device 225 either before or after execution by the processor(s) 210.

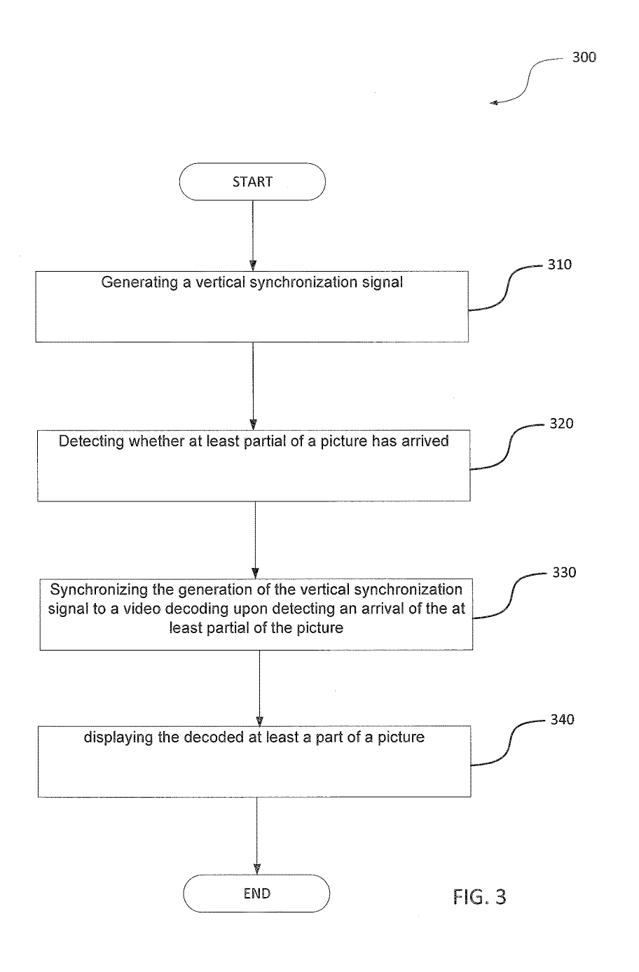

FIG. 3 is a flowchart illustrating a method 300 of reducing latency according to an embodiment of the invention. The method 300 of reducing latency comprises, generating, in block 310, a vertical synchronization signal (or VSYNC signal); detecting, in block 320, whether at least a part of a picture has been received; synchronizing, in block 330, the generation of the vertical synchronization signal to a video decoding of the at least a part of the picture, upon detecting an receiving of the at least the part of the picture; and displaying, in block 340, the decoded at least a part of a picture. Note the VSYNC is generated internally within the SOC (system on a chip). On SMP (Sigma Media Processor, which is the name given by Sigma Designs to a family of chips) SOC, a “video output block” generates the VSYNC. The VSync is generated by a hardware block, which is referred to as the “video output block”. The timing is programmed as desired. Once ready, the video output block will output the timing.

For example, in block 330, the method may synchronize the generation of the VSYNC signal to a video decoding of a part of the picture, upon detecting a receiving of the part of the picture. Alternatively, in block 330, the method may synchronize the generation of the VSYNC signal to a video decoding of a complete picture, upon detecting an receiving of the complete picture.

In an embodiment of the invention, as the generation of the VSYNC signal is synchronized to a video decoding, that means the VSYNC signal is served as a slave, and the video decoding is served as a master. In other words, the VSYNC is generated as a result of the video decoding process. The advantage of having the decoding as the master and the generation of VSYNC as a slave is that the latency can be reduced by at maximum one VSYNC period. On the one hand, if the VSYNC generation triggers the decoding process, the added latency is different between when the start of the frame is received, and the start of the VSync. For example, when VSYNC is taken as the trigger to start for viewing a frame. The earlier in absolute time the VSYNC is generated, the earlier the frame can be viewed.

By contrast, if the decoding/reception process is the master and it is the one that causes the generation of the VSYNC, no latency is added.

For example, suppose that VSYNC is generated once every second (this is for illustrative purpose only, and the actual frequency that VSYNC is generated can be varied dramatically). Further, suppose a compressed frame is received once every second. Suppose a frame is received (for illustrative purpose only, and assume that the frame is decoded instantaneously as it is received) at absolute time 0.25 s, 1.25 s, 2.25 s, etc.

By making decoding/reception as a master, because the VSYNC is started as soon as the frame is received, the added latency is 0, which guarantees that the added latency is always 0.

Alternatively, detecting, in block 320, whether the at least a part of the picture has been received further comprises: determining, by a display, whether a notification from the video decoder is received. Note the video decoder and the display are separate components. The video decoder may be a hardware block that is controlled by firmware.

Alternatively, the notification includes an interrupt. The interrupt is generated by the video decoder.

Alternatively, synchronizing, in block 330, the generation of the vertical synchronization signal to the video decoding further comprises triggering the VSYNC generation upon detecting the receiving of the at least a part of the picture. Note a threshold for the size of the part of a picture that is sufficient for decoding may be set as one complete row of macroblocks. In other words, the VSYNC generation is triggered upon detecting the receiving of at least one complete row of the macroblocks.

Alternatively, synchronizing, in block 330, the generation of the vertical synchronization signal to the video decoding further comprises starting the video decoding of the at least a part of a picture upon detecting the receiving of the at least a part of the picture.

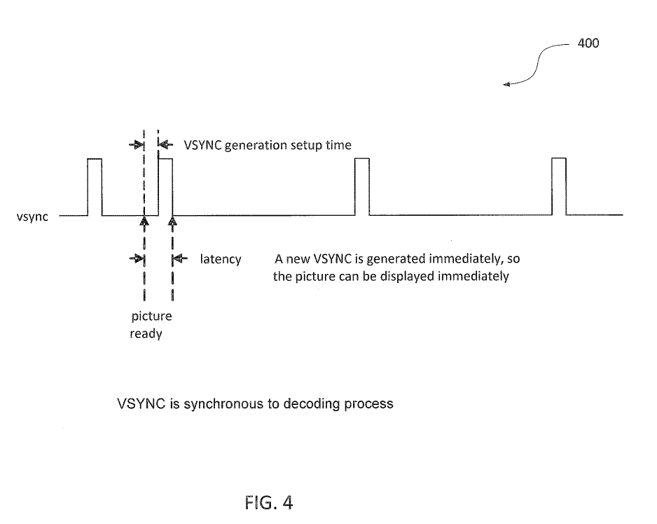

FIG. 4 is a diagram illustrating a time sequence for VSYNC signal according to an embodiment of the invention.

As shown in FIG. 4, VSYNC signal is synchronous to the decoding process. Further, as shown in FIG. 4, a new VSYNC is generated immediately after the picture is decoded (ready), therefore the picture can be displayed immediately.

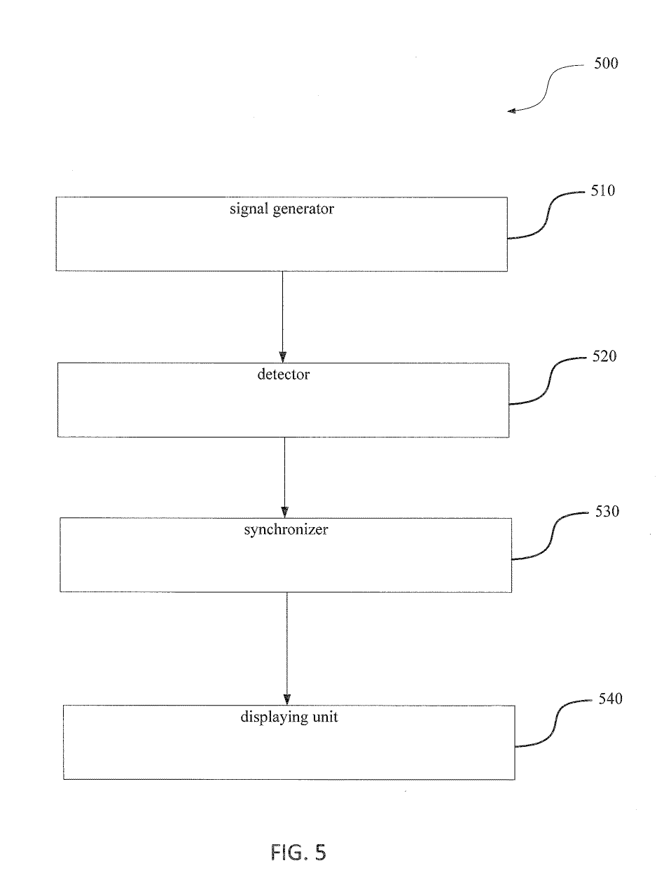

FIG. 5 is a block diagram illustrating a circuit 500 according to an embodiment of the invention. Referring back to FIG. 2, the circuit 500 may reside in both the processor 210 and the working memory 235.

The circuit 500 for reducing latency, comprises a signal generator 510 configured to generate a vertical synchronization signal (VSYNC); a detector 520 configured to detect whether at least a part of a picture has been received; a synchronizer 530 configured to synchronize the generation of the vertical synchronization signal to a video decoding of the at least a part of the picture upon detecting receiving of the at least the part of the picture; and a displaying unit 540, configured to display the decoded at least a part of a picture. Note the decoder 520, for example, a video detector, knows that an uncompressed frame is available because it is the entity that is generating the uncompressed frames. The signal generator 510 can also be called as a VSYNC generator, and it may be a hardware block controlled by software. For example, the software that controls the VSYNC generation and display processing is written in programming language “C”. The software that controls the decoding runs on a proprietary Reduced Instruction-Set Computer (RISC) processor, and thus in a proprietary assembly language. In other words, the software may manage both the decoding and display process. Alternatively, the decoder may be a hardware block controlled by firmware.

Note once the display unit 540 receives notification from the decoder (most likely via an interrupt) that an uncompressed frame is available for display, the display starts the VSYNC generation at exactly this time so the actual display of the picture starts as soon as possible, thus reducing latency.

Alternatively, the displaying unit 540 is further configured to determine whether a notification from the video decoder is received.

Alternatively, the notification includes an interrupt.

Alternatively, the synchronizer 530 is further configured to trigger the VSYNC generation upon detecting the receiving of the at least a part of the picture.

Alternatively, the synchronizer 530 is further configured to start the video decoding upon detecting the receiving of the at least a part of the picture.

From the foregoing, it will be appreciated that specific embodiments of the invention have been described herein for purposes of illustration, but that various modifications may be made without deviating from the scope of the invention. Accordingly, the invention is not limited except as by the appended claims.

I/We claim:

1. A method of reducing latency, comprising:
generating a vertical synchronization signal (VSYNC);
detecting whether at least a part of a picture has been received;
synchronizing the generation of the vertical synchronization signal to a video decoding of the at least a part of the picture upon detecting an receiving of the at least the part of the picture; and
displaying the decoded at least a part of a picture.

2. The method of claim 1, wherein detecting whether the at least a part of the picture has been received further comprises:
determining, by a display, whether a notification from the video decoder is received.

3. The method of claim 2, wherein the notification includes an interrupt.

4. The method of claim 1, wherein synchronizing the generation of the vertical synchronization signal to the video decoding further comprises triggering the VSYNC generation upon detecting the receiving of the at least a part of the picture.

5. The method of claim 1, wherein synchronizing the generation of the vertical synchronization signal to the video decoding further comprises starting the video decoding of the at least a part of a picture upon detecting the receiving of the at least a part of the picture.

6. A circuit for reducing latency, comprising:
a signal generator, configured to generate a vertical synchronization signal (VSYNC);
a detector configured to detect whether at least a part of a picture has been received;
a synchronizer configured to synchronize the generation of the vertical synchronization signal to a video decoding of the at least a part of the picture upon detecting receiving of the at least the part of the picture; and
a displaying unit, configured to display the decoded at least a part of a picture.

7. The circuit of claim 6, wherein the displaying unit is further configured to determine whether a notification from the video decoder is received.

8. The circuit of claim 7, wherein the notification includes an interrupt.

9. The circuit of claim 8, wherein the synchronizer is further configured to trigger the VSYNC generation upon detecting the receiving of the at least a part of the picture.

10. The circuit of claim 6, wherein synchronizing the generation of the vertical synchronization signal to the video decoding further comprises starting the video decoding upon detecting the receiving of the at least a part of the picture.
